(19) United States
(12) Patent Application Publication
(10) Pub. No.: US 2024/0031489 A1
(43) Pub. Date: Jan. 25, 2024

(54) Automatic Cloud Normalization of Audio Transmissions for Teleconferencing

(71) Applicant: Google LLC, Mountain View, CA (US)

(72) Inventors: Henrik Fahlberg Lundin, Sollentuna (SE); Alessio Bazzica, Stockholm (SE); Esbjörn Dominique, Stockholm (SE); Per Erik Daniel Johansson, Stockholm (SE); Tomas Gunnarsson, Stockholm (SE); Markus Lindroth, Uppsala (SE); Karl Allan Tore Rudberg, Stockholm (SE)

(21) Appl. No.: 17/871,513

(22) Filed: Jul. 22, 2022

(51) Int. Cl. H04M 3/56; G10L 21/0364; G10L 25/51; G10L 25/84; G10L 21/028; G10L 21/034; G10L 17/06

(52) U.S. Cl. CPC H04M 3/568; G10L 21/0364; G10L 25/51; G10L 25/84; G10L 21/028; G10L 21/034; G10L 17/06

(57) ABSTRACT

Methods, systems, and apparatus for normalizing audio transmissions from multiple endpoints within a teleconference. A first audio transmission from a first participant of a teleconference can be received for presentation at the teleconference. The first audio transmission can be analyzed to classify one or more audio signatures of the first audio transmission as speech. A difference can be determined between the audio level of the one or more audio signatures and an audio level of second transmissions. Based on the difference, the first audio transmission can be normalized to adjust a gain of the first transmission. The transmission can be output to the teleconference.

### FIELD

The present disclosure relates generally to teleconferencing. More particularly, the present disclosure relates to automatic, cloud-based normalization of audio transmissions between participants of a teleconference.

### BACKGROUND

The development of teleconferencing has allowed real-time communication between different users at different locations. Often, participants in a teleconference will utilize different types of devices to participate in the teleconference (e.g., mobile devices, tablets, laptops, dedicated teleconferencing devices, etc.). Generally, these devices each provide varying capabilities (e.g., processing power, bandwidth capacity, etc.), hardware (e.g., camera/microphone quality), connection mechanisms (e.g., dedicated application client vs. browser-based web application) and/or varying combinations of the above (e.g., a browser on a PC, dedicated teleconferencing hardware and client, etc.). Due to these differences, audio transmissions from different devices can vary substantially.

### SUMMARY

Aspects and advantages of embodiments of the present disclosure will be set forth in part in the following description, or can be learned from the description, or can be learned through practice of the embodiments.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates an example figure that depicts differences between audio levels of transmissions made by differing types of endpoints over a period of time, according to example embodiments of the present disclosure.

FIG. 2 illustrates a block diagram of an example environment for automatic normalization of audio transmissions from multiple endpoints within a cloud network according to example embodiments of the present disclosure.

FIG. 3 illustrates an example flow chart diagram of an example method for automatic normalization of audio transmissions in a cloud network according to example embodiments of the present disclosure.

FIG. 4 illustrates an example environment for cloud normalizer processing according to example embodiments of the present disclosure.

FIG. 5 illustrates an example environment for cloud normalization and top-k-selection according to example embodiments of the present disclosure.

FIG. 6 illustrates a block diagram of computing devices that may be used to implement the systems and methods described in this document, as either a client or as a server or multiple servers.

Reference numerals that are repeated across plural figures are intended to identify the same features in various implementations.

### DETAILED DESCRIPTION

Generally, the present disclosure is directed to cloud-based normalization of multiple audio transmissions for teleconferencing (e.g., within a cloud network). A teleconference is a communication session in which multiple participants exchange audio transmissions (e.g., a videoconference, audioconference, multi-media conference, etc.). Normalization of audio transmissions generally refers to adjustment of audio transmissions to a target level or range. For example, gain may be applied to an audio transmission to bring an amplitude of the audio transmission to a target level or range.

When participating in a teleconference, different participants may utilize devices with different capabilities (e.g., processing power) and/or hardware (e.g., camera and/or microphone quality) to connect to the teleconference. This can result in a disjointed experience, as different participants may transmit differently and at varying quality. The problem of providing a seamless, consistent user experience within a teleconference is solved by performing automatic normalization to the audio transmissions (e.g., within the cloud or at the client device(s)).

The following example methods and systems describe normalizing audio transmissions from multiple endpoints (e.g., participant devices, etc.) within a teleconference. For example, an audio transmission from a participant (e.g., from a device utilized by the participant) can be received for presentation at a teleconference. This audio transmission can be analyzed to classify one or more audio signatures of the audio signal as speech. A difference can be determined between the audio signature(s) and audio transmissions from other participants that were received prior. Based on the difference, the audio transmission can be normalized. For instance, the normalization can adjust a gain of the audio transmission relative to the other audio transmissions. After normalizing the audio transmission, the audio transmission can be output for presentation within the teleconference.

Automatic: As used herein, automatic, or automated, refers to actions that do not require explicit permission or instructions from users to perform. For example, an audio normalization service that performs normalization actions for audio transmissions without requiring permissions or instructions to perform the normalization actions can be considered automatic, or automated.

Broadcast: As used herein, broadcast or broadcasting refers to any real-time transmission of data (e.g., audio data, video data, AR/VR data, etc.) from a user device and/or from a centralized device or system that facilitates a teleconference (e.g., a cloud computing system that provides teleconferencing services, etc.). For example, a broadcast may refer to the direct or indirect transmission of data from a user device to a number of other user devices. It should be noted that, in some implementations, broadcast or broadcasting may include the encoding and/or decoding of transmitted and/or received data. For example, a participant broadcasting video data may encode the video data using a codec. Participants receiving the broadcast may decode the video using the codec.

Participant: As used herein, a participant may refer to any user, group of users, device, and/or group of devices that participate in a live communication session in which information is exchanged (e.g., a teleconference, videoconference, etc.). More specifically, participant may be used throughout the subject specification to refer to either participant(s) or participant device(s) utilized by the participant(s) within the context of a teleconference. For example, a group of participants may refer to a group of users that participate remotely in a videoconference with their own respective devices (e.g., smartphones, laptops, wearable devices, teleconferencing devices, broadcasting devices, etc.). For another example, a participant may refer to a group of users utilizing a single computing device for participation in a teleconference (e.g., a dedicated teleconferencing device positioned within a meeting room, etc.). For another example, participant may refer to a broadcasting device (e.g., webcam, microphone, etc.) unassociated with a particular user that broadcasts data to participants of a teleconference (e.g., an audio transmission passively recording an auditorium, etc.). For yet another example, participant may refer to a bot or an automated user that participates in a teleconference to provide various services or features for other participants in the teleconference (e.g., recording data from the teleconference, providing virtual assistant services, providing testing services, etc.).

As such, it should be broadly understood that any references to a “participant” exchanging data (transmitting data, receiving data, etc.), or processing data (e.g., encoding data, decoding data, applying codec(s) to data, etc.), or in any way interacting with data, refers to a computing device utilized by one or more participants.

Additionally, as described herein, a participant may exchange information in a real-time communication session (e.g., a teleconference) via an endpoint. An endpoint can be considered a device, a virtualized device, or a number of devices that allow a participant to participate in a teleconference.

Teleconference: As used herein, a teleconference (e.g., videoconference, audioconference, media conference, Augmented Reality (AR)/Virtual Reality (VR) conference, etc.) is any communication or live exchange of data (e.g., audio data, video data, AR/VR data, etc.) between a number of participants. Specifically, as used herein, a teleconference includes the exchange of audio transmissions. For example, a teleconference may refer to a videoconference in which multiple participants utilize computing devices to transmit audio data and video data to each other in real-time. For another example, a teleconference may refer to an AR/VR conferencing service in which audio data and AR/VR data (e.g., pose data, image data, etc.) sufficient to generate a three-dimensional representation of a participant is exchanged amongst participants in real-time. For another example, a teleconference may refer to a conference in which audio signals are exchanged amongst participants over a mobile network or public switched telephone network (PSTN). For yet another example, a teleconference may refer to a media conference in which participants may exchange differing types or combinations of data based on hardware and/or bandwidth limitations (e.g., audio data, video data, AR/VR data, a combination of audio and video data, etc.).

With reference now to the Figures, example embodiments of the present disclosure will be discussed in further detail.

In a typical teleconference, audio transmissions come in from a number of different types of client devices of participants of the teleconference. These devices can vary based on device type, brand, compute resource and hardware capability/quality, software executed by the client device, etc. (e.g., browsers, codecs, etc.). For example, some clients may use one type of browser on a laptop/desktop or one type of teleconferencing application on a mobile device to enter a teleconference, while others may use other types of browsers or other types of teleconferencing applications. There are also dedicated meeting rooms equipped with dedicated teleconferencing peripherals (e.g., omni-directional microphones, networked webcams, etc.), as well as PSTN users connecting to the meeting (e.g., via phone dial-in) and interop bridging from other conferencing systems. All these systems and devices must be able to connect to a teleconferencing session.

Ideally, all devices utilized by participants should send audio at a nominal level, but in practice that is not the case. Confusion about governing standards, decisions made in the past, and legacy code all contribute to a situation in which devices transmit at different audio levels depending on which type of configuration they are using. The following systems and methods are a way to normalize the participants' experiences by making sure that all participants in a teleconference are heard at similar levels (e.g., participants in a videoconference call should have a microphone level of similar loudness). A listening participant should not have to adjust their volume manually for different speakers within the teleconference.

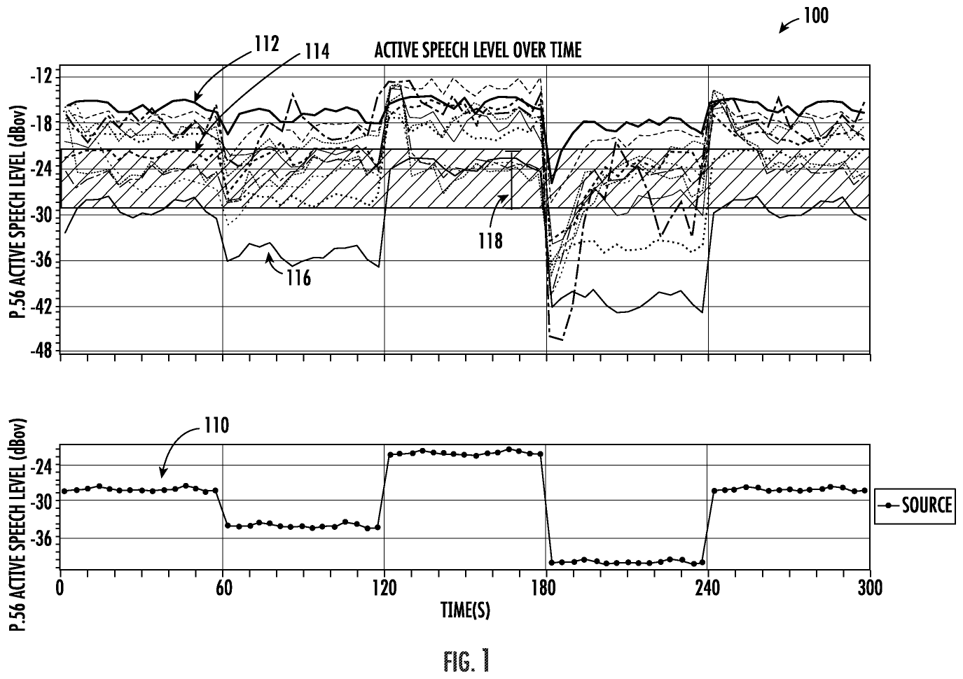

FIG. 1 illustrates an example figure that depicts differences between audio levels of transmissions made by differing types of endpoints over a period of time, according to example embodiments of the present disclosure. An endpoint can refer to a device utilized by a participant of a teleconference to exchange data in a teleconferencing session (e.g., to transmit audio data, receive audio data, play audio data to the participant, etc.). The endpoints of each participant connecting to a teleconferencing session can have different types of audio signal processing. Some endpoints, for example, can process the audio and transmit the audio to a computing system (e.g., a cloud computing system) that facilitates the teleconference using different audio processing modules, while other endpoints can use device-specific processing. For example, a dedicated teleconferencing device (e.g., an omni-directional microphone, etc.) may perform audio signal processing before transmitting audio (e.g., normalization of the audio signal, etc.). It is also possible to dial into a teleconference from a phone via the public switched telephone network (PSTN). System 100 shows an active speech level over time for a number of different participant endpoints, such as the audio from endpoint 112, endpoint 114, and endpoint 116. An active speech level refers to an audio level (e.g., as measured in dBov) of an audio signature that has been identified as active speech. For example, the audio signature corresponding to a speaker's voice within an audio transmission can have a corresponding active speech level, while an audio signature corresponding to background noise in the audio transmission can be omitted.

The microphone send level can vary quite a bit between the endpoints in a teleconference. For example, source audio 110 is audio that is transmitted using various endpoints 112-116. As the endpoints 112, 114, and 116 (e.g., participant devices) are configured differently, they each provide a varying active speech level when transmitting the source audio 110. The acceptable range 118 illustrates an example acceptable range between −30 and −22 dBov. The large variance in the audio levels between endpoints 112-116 illustrated in FIG. 1 can cause a bad user experience in a multi participant teleconference, as some participants can transmit at high audio levels while other participants transmit at low audio levels. In extreme cases, participants might have to manually change their playback volume depending on which person is speaking.

The systems and methods herein provide a way to normalize the audio transmissions of the endpoints (e.g., devices used by participants) in a teleconference within a cloud network so that users do not have to change playback volume based on the active speaker. The normalization process can adjust the audio of a teleconference such that each participant, such as endpoint 112, endpoint 114, and endpoint 116, is within an acceptable range 118.

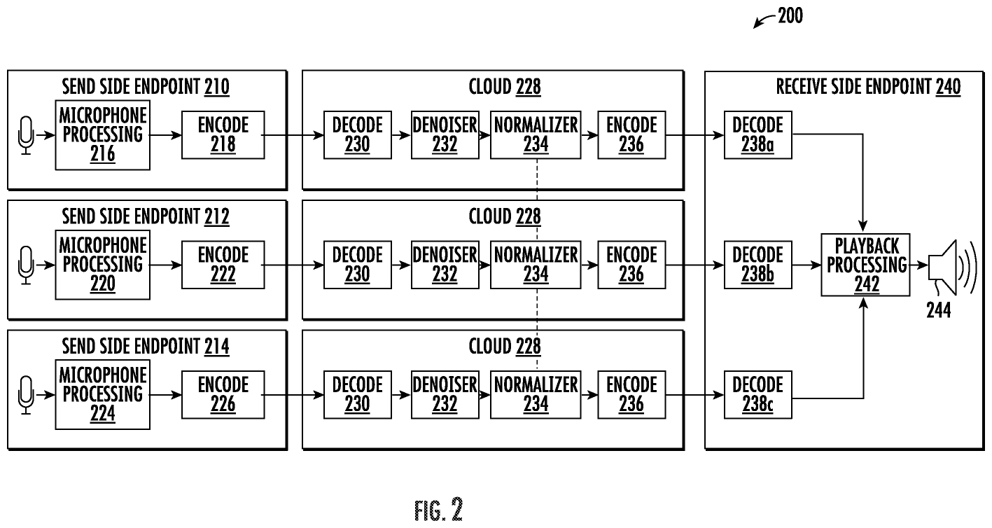

FIG. 2 illustrates a block diagram of an example environment for normalizing audio transmissions from multiple endpoints within a cloud network according to example embodiments of the present disclosure. The example system 200 includes a cloud network 228 (hereinafter also referred to as “cloud”) that can be distributed over multiple locations, and/or include or be connected with a local area network (LAN), a wide area network (WAN), the Internet, or a combination thereof. Cloud 288 can include one or more computing devices configured to facilitate public and/or private teleconferencing sessions for multiple participants. For example, cloud 288 may include a computing system configured to receive transmissions from endpoints, process the audio transmissions, and broadcast the audio transmissions to other endpoints. For another example, cloud 288 may be or otherwise include a distributed network of computing devices or systems that collectively facilitate teleconferencing sessions for multiple participants. For yet another example, cloud 288 may include, or may interact with, mobile networks such as Fifth Generation New Radio (5G NR) networks, PSTN networks, etc. As such, it should be broadly understood that the cloud 228 can be or otherwise include one or more computing device(s) that are configured to provide services that facilitate teleconferencing sessions. Cloud 228 can connect send side endpoints 210, 212, and 214 (e.g., participant endpoints) to a receive side endpoint 240 (e.g., the participant render side) that outputs the audio signals in the teleconference.

In some embodiments, cloud 228 can receive, from a send side endpoint, an audio transmission for presentation at, or in communication with, a teleconference (e.g., rendered at the receive side endpoint 240, etc.). For example, send side endpoint 210 can send an audio transmission to cloud 228, which can be normalized in relation to the audio transmissions that cloud 228 also received from send side endpoint 212 and send side endpoint 214. While FIG. 2 shows three send side endpoints, any number of send side endpoints can be included within the teleconference.

A send side endpoint associated with a participant can be any electronic device that is capable of requesting and receiving resources over the network, including cloud 228. Example endpoints can include, but are not limited to: personal computers, tablet computers, mobile communication devices (e.g., smartphones), personal digital assistants, and other devices that can send and receive data with cloud 228. In some implementations, the send side endpoint may be a virtualized device. For example, if a participant in the teleconference is an automated service (i.e., a “bot”), the virtualized device may be utilized for purposes of interfacing with the cloud 228 in the same manner as other endpoints. An endpoint can typically include, or otherwise execute, user application(s), such as a web browser, to facilitate the sending and receiving of data over cloud 228. The web browser can interact with various types of web applications, such as a teleconferencing application or service.

It should be noted that, as used herein, a “service” may refer to any collection of physical or virtualized computing resources, software, etc. that are configured to provide or otherwise implement a service. For example, a microphone processing service may be a collection of software and computing resources collectively configured to capture and adjust audio transmissions to provide a microphone processing service.

The send side endpoints may each include a microphone processing service that captures speech and/or other audio. That audio may be passed through an encode service to compress and make the audio transmission more robust against loss or imperfections in the cloud network 228. Additionally and/or alternatively, the audio transmission can be encrypted within an encode service to preserve privacy and security. For example, send side endpoint 210 can capture audio via microphone service 216, which is then encrypted by encode service 218 before being sent to cloud 228. Each send side endpoint may have their own audio processing and encrypting, so send side endpoint 212 can include a separate microphone processing service 220 encrypted by a separate encode service 222; and send side endpoint 214 can include a separate microphone processing service 224 encrypted by a separate encode service 226.

As described previously, the cloud 228 can include physical or virtualized computing resources (e.g., computing device(s), computing system(s), server(s), etc.) configured to process each audio transmission before transmitting the audio transmissions to receive side endpoint 240 (which renders or otherwise facilitates the teleconference). In particular, the audio transmission from send side endpoint 210 can be decrypted by decode service 230 when received by cloud 228.

Additionally and/or alternatively, noise within the decrypted audio transmission can be removed by a denoiser service 232. The denoiser service 232 can analyze the audio transmission to classify audio portion(s) of the audio transmission as speech or noise. For example, in some embodiments, the denoiser service 232 can analyze the audio transmission from send side endpoint 210 to identify audio signature(s) (e.g., portions of the transmission) as noise based on a statistical analysis identifying a generalized mean applied to the audio transmission. Any appropriate statistical analysis for noise detection may be used, such as statistical methods relating to error deviation and/or a generalized mean, such as the root mean square (RMS). The denoiser service 232 can, after identifying what components within the audio transmission is noise or speech, segregate the audio transmission into noise components and speech signatures. The noise signatures can then be dynamically and/or automatically removed from the audio transmission in real-time (i.e., as the transmission is received) or near real-time (i.e., shortly after the transmission is received, after syncing the transmissions with other transmissions, etc.). The denoiser service 232 can determine an active speech level based on the audio transmission segregation, once the noise has been removed.

The audio transmission is then processed by the normalizer service 234, which can normalize the audio transmission with other audio transmissions that are transmitted concurrently or previously within the teleconference. The normalizer service 234 can adjust a gain of the audio transmission relative to the other audio transmissions such that the difference between the audio levels of the send side endpoints 210-214 are adjusted to be within a predefined range of amplitude levels (e.g., a range of amplitude levels that is determined to be optimal for teleconferencing, etc.).

For example, the normalizer service 234 may determine a difference between the audio signatures of the audio transmission from a send side (e.g., 210, etc.) and other transmissions from other participants (e.g., 212, 214, etc.). A gain can be applied to adjust the audio transmission from send side endpoint 210 to reduce the difference between the audio levels of the transmissions from send side endpoint 212 and send side endpoint 214. Likewise, a gain can be applied to adjust the audio transmission from send side endpoint 212 to reduce the difference between the audio levels of the transmissions from send side endpoint 210 and send side endpoint 214; and a gain can be applied to adjust the audio transmission from send side endpoint 214 to reduce the difference between the audio levels of the transmissions from send side endpoint 210 and send side endpoint 212. Therefore, if the audio transmission is below the mean of the other audio transmissions, the gain can be applied to increase the loudness (e.g., increase the amplitude levels) of the audio transmission to match the other audio transmission within the predefined range. If the audio transmission is below the mean of the other audio transmissions, however, the gain can then be applied to decrease the loudness (e.g., decrease the amplitude levels) of the audio transmission to match the other audio transmissions within the predefined range. The predefined range of amplitude levels can be an accepted range (e.g., see the accepted range 118 in FIG. 1), such as within a range of values (e.g., within ˜6 dB). Each audio transmission can have an automatic gain control applied to each corresponding transmission to the teleconference.

Additionally, and/or alternatively, the normalizer service 234 can normalize the transmissions to an absolute target level, as opposed to relative to the other audio transmissions.

Additionally, and/or alternatively, the normalizer service 234 can normalize the audio transmissions based on the classification of audio signature(s) as speech. For example, the denoiser service 232 can analyze the audio signature to identify if any portion of the audio is speech (e.g., matches a speech signature). Any voice activity detection algorithm (VAD) used in speech processing can determine when there is speech present in the audio transmission. For those audio signatures that are classified as speech, the normalizer service 234 can utilize those signatures to determine the range within which all the audio transmissions are normalized. The other signatures that are noise, silence, and/or otherwise not classified as speech, the normalizer service 234 can disregard, remove, and/or otherwise take out those signatures when the range for normalization is determined. This can avoid unnecessary coding/transmission of silence packets in Voice over Internet Protocol (VoIP) applications, saving on computation and on network bandwidth.

In some embodiments, the normalization service 234 can adjust an audio level of the audio transmissions to match a target output level. For example, the target output level from the normalizer service 234 can be defined so that peak signals with a transmission are close to 0 dBFS. The root mean square (RMS) will be significantly lower as speech has a relatively high crest factor. This can be embodied in a limiter, which prevents peaks within an audio transmission with a gain applied from exceeding 0 dBFS. The limiter's effects can compress the audio transmission, so a suitable level of compression from the limiter can be determined that still preserves audio quality. In this way, the limiter can provide a threshold or cut-off value, in which the normalized audio transmissions do not have an audio level above a certain value (e.g., never reaches a loudness above a threshold).

After normalizing the audio transmission, the audio transmissions can then be output for presentation within the teleconference. Cloud 228 can encrypt the outgoing audio transmissions through the encode service 236, which are then received by receive side endpoint 240. The receive side endpoint 240 can decrypt the audio transmission through decode service 238, and then playback processing service 242 can output the audio transmission with loudspeaker 244.

Although FIG. 2 shows the denoiser service 232 and the normalizer 234 operating in the cloud network 228, it is also possible to implement the denoiser service 232 and/or the normalizer service 234 at some or all of the client devices, such as, for example, at each receive side endpoint 240.

It should be noted that, send side endpoints 210, 212, and 214 may each transmit audio transmissions to the cloud 228 at different points in time. For example, send side endpoint 210 and 212 may transmit respective audio transmissions to the cloud 228 at one point in time, and send side endpoint 214 may transmit an audio transmission at a later point in time. In such fashion, the audio transmission of send side endpoint 214 can be normalized by the normalizer module 234 of the cloud 228 based on differences between the transmission of send side endpoint 214 and the prior transmissions of send side endpoints 210 and 212.

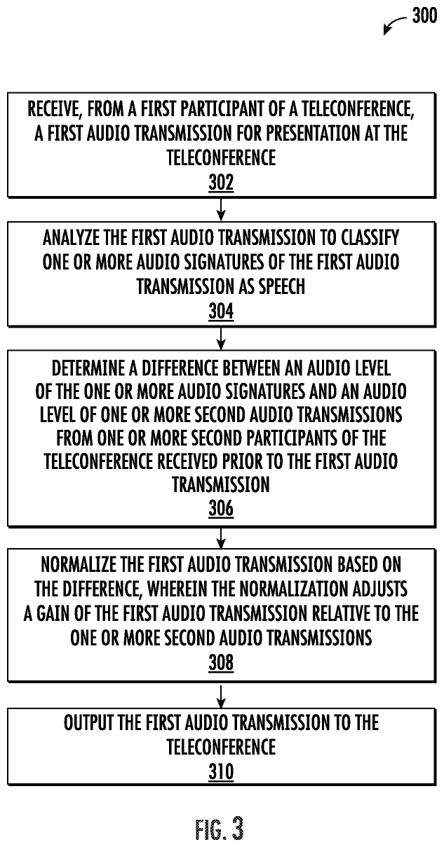

FIG. 3 illustrates an example flow chart diagram of an example method for automatic and normalization of audio transmissions in a cloud network according to example embodiments of the present disclosure. Although FIG. 3 depicts operations performed in a particular order for purposes of illustration and discussion, the methods of the present disclosure are not limited to the particularly illustrated order or arrangement. The various operations of the method 300 can be omitted, rearranged, combined, and/or adapted in various ways without deviating from the scope of the present disclosure.

At operation 302, a computing system (e.g., a cloud computing system, a cloud teleconferencing server, etc.) receives a first audio transmission from a first participant in a teleconference for presentation at the teleconference.

At operation 304, the computing system analyzes the first audio transmission to classify one or more audio signatures of the first audio transmission as speech (e.g., various portions of the transmission corresponding to differing sources of audio, etc.).

At operation 306, the computing system determines a difference between an audio level of the one or more audio signatures and an audio level of one or more second audio transmissions from one or more second participants of the teleconference received prior to the first audio transmission.

At operation 308, the computing system normalizes the first audio transmission based on the difference. The normalization adjusts a gain of the first audio transmission relative to the one or more second audio transmissions. In some implementations, the normalization adjusts the audio level of the first audio transmission to match a target output level, and wherein the gain applied to the first audio transmission adjusts the audio level of the first audio transmission to within a predefined range of amplitude levels. In some implementations, the target output level is based at least in part on the one or more second audio transmissions from the one or more second participants, and wherein first audio transmission and the one or more second audio transmissions are received within a same session of the teleconference. In some implementations, the first audio transmission and the one or more second audio transmissions are received within a first session of the teleconference, and wherein the target output level is based at least in part on other audio transmissions received within one or more second sessions of the teleconference occurring prior to the first session of the teleconference.

At operation 310, the computing system outputs the first audio transmission to the teleconference. In some implementations, the computing system further analyzes the first audio transmission to identify one or more other audio signatures of the first audio transmission as noise based on a statistical analysis identifying a generalized mean applied to the first audio transmission. The computing system segregates the first audio transmission into noise components and speech components. The computing system dynamically removes the noise components from the first audio transmission. The computing system determines an active speech level based on the first audio transmission segregation. In some implementations, each audio transmission has an automatic gain control applied to each corresponding transmission to the teleconference.

In some implementations, the computing system further monitors the first audio transmission to the teleconference, wherein a gain has been applied to the first audio transmission after normalization. Based on a detection of the audio level of the first audio transmission being above a threshold value, the computing system applies a limiter service to attenuate the first audio transmission to dynamically bring the audio level below the threshold value.

In some implementations, the computing system further applies a voice activity detection (VAD) analysis to the first audio transmission. Based on the VAD analysis, the computing system determines that the one or more audio signatures of the first audio transmission from the first participant corresponds to an active speaker. The computing system selects the first audio transmission for presentation at the teleconference based on a comparison between the first audio transmission and audio transmissions from other participants of the teleconference after normalizing, wherein the active speaker within the first audio transmission is determined to meet a threshold ranking. The computing system outputs the first audio transmission to the teleconference while withholding output of the other audio transmissions that do not meet the threshold ranking.

In some implementations, the computing system determines a first speaker and a second speaker is present within the first audio transmission, wherein the first speaker has a speech level different from the second speaker. The computing system normalizing the first speaker and the second speaker within the first audio transmission.

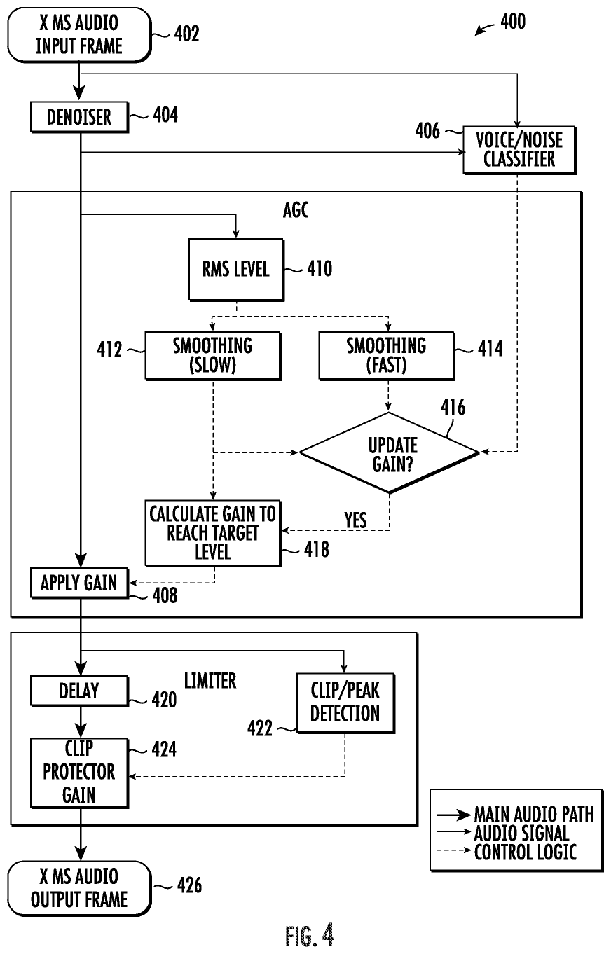

FIG. 4 illustrates an example environment for cloud normalizer processing according to example embodiments of the present disclosure. In this particular embodiment, cloud environment 400 receives an audio input frame 402 from an endpoint. The denoiser 404 can predict two complete transmissions, by separating the speech and noise components of the input transmission. Additionally, and/or alternatively, the audio transmission may be processed through a voice/noise classifier service 406, which classifies certain portions of the audio transmission as speech or noise, using the noisy audio transmission and/or the denoised audio transmission as input. In some embodiments, the voice/noise classifier service 406 can take the place of the denoiser 404. In other embodiments, the voice/noise classifier service 406 can act as a supplement to the denoiser 404, where the portions of the audio transmission that are classified as speech are not considered by the denoiser 404 when determining and then taking out the noise within an audio transmission.

Additionally, and/or alternatively, the voice activity detection algorithm (VAD) can operate as a service independent of the denoiser 404. For example, a VAD service (not shown) can receive the audio input frame 402 without any prior processing (e.g., no noise taken out of the audio transmission). The VAD service could identify when there is speech present in the audio transmission. In other embodiments, the VAD service could make determinations of whether there is a speaker based on an audio transmission where noise has already been taken out.

Once the noise has been removed and/or cleaned from the received audio transmission, the automatic gain control (AGC) service can normalize the audio transmission in relation to the other audio transmissions within the teleconference. Speech within the received audio transmission can be identified by a speech level estimator service, which can identify which portions of an audio transmission are characteristic of speech and/or the loudness levels of the speech. According to one example embodiment, the AGC service can determine a generalized mean of the audio transmission (e.g., RMS level 410). Additionally, and/or alternatively, a detector based on energy thresholds and temporal smoothing can be run on the audio transmission after the cloud denoiser 404. Such a detector should be sufficient to determine when the current audio level should be used to update the active speech level estimation. In the example shown, in fast smoothing 414, an RMS level can be taken over a short period of time for quick active speech level estimation. However, if more accuracy is desired, especially if the transparency and/or noise suppression occasionally gets worse, slow smoothing 412 can be applied that determines an RMS level over a longer period of time. The longer the period of time, the more data is analyzed with the audio frame and the smoothing will not be subject to temporary fluctuations in active speech level. In some embodiments, both fast smoothing 414 and slow smoothing 412 are used, where the slow smoothing 412 is applied subject to gain updates 416 based on the output from fast smoothing 414.

The gain that needs to be applied to the audio transmission to reach a normalized level can be calculated 418 by the AGC service. That gain is then applied 408 to the audio transmission, where it is then sent to a limiter service.

The limiter service can monitor the normalized audio transmission to the teleconference. In some embodiments, a delay 420, for example, can be applied to the normalized audio transmission—this delay allows the limiter service to apply a clip/peak detection analysis 422 on the normalized audio transmission to determine how high and/or where the peaks within the transmission are occurring. If a peak exceeds a threshold value (e.g., is too high), then a clip protector gain 424 can be applied that brings down the peak within an acceptable value. The clip protector gain 424 can in some embodiments provide a hard clipping (e.g., any peak that would be above the threshold range would be “clipped”—or reduced—to the threshold vale), and in other embodiments adjust the gain to reduce the entire normalized audio transmission. In this way, based on a detection of an audio level of the normalized audio transmission being above a threshold value, the limiter service is applied to attenuate the normalized audio transmission to dynamically bring the audio level below the threshold value. The normalized audio transmission is then output to the teleconference in an audio output frame 426.

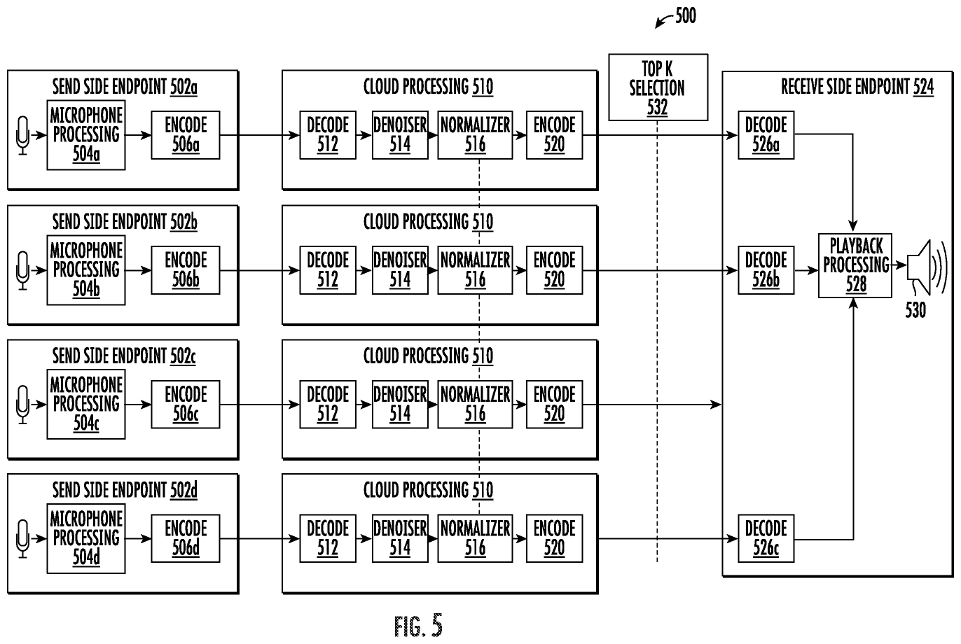

FIG. 5 illustrates an example environment for cloud normalization and top-k-selection according to example embodiments of the present disclosure. Similar to that disclosed in FIG. 2, the example system 500 includes a cloud network 510 at a remote locations, distributed over multiple locations, and/or include or be connected with a local area network (LAN), a wide area network (WAN), the Internet, or a combination thereof. Cloud 510 can connect multiple send side endpoints (e.g., participant endpoints) to a receive side endpoint (e.g., the participant render side) that outputs the audio transmissions in the teleconference.

Cloud 510 can receive, from multiple endpoints associated with each of their corresponding participants, audio transmissions for presentation at a teleconference rendered at the receive side endpoint 524. For example, send side endpoint 502a can send an audio transmission to cloud 510, which can be normalized in relation to the audio transmissions that cloud 510 also received from send side endpoint 502b, send side endpoint 502c, and send side endpoint 204d. While FIG. 5 shows four send side endpoints, any number of send side endpoints can be included within the teleconference.

The send side endpoints may each include a microphone processing service that captures speech and/or other audio. That audio may then be encrypted within an encode service to preserve privacy and security. For example, send side endpoint 502a can capture audio via microphone service 504a, which is then encrypted by encode service 506a before being sent to cloud 510. Each send side endpoint may have their own audio processing and encrypting, so send side endpoint 502b can include a separate microphone processing service 504b encrypted by a separate encode service 506b; send side endpoint 502c can include a separate microphone processing service 504c encrypted by a separate encode service 506c; and send side endpoint 502d can include a separate microphone processing service 504d encrypted by a separate encode service 506d.

Cloud 510 can process each audio transmission before sending the audio transmissions to receive side endpoint 524 (which renders the teleconference). In particular, the audio transmission from send side endpoint 502a can be decrypted by decode service 512 when received by cloud 510.

Additionally, and/or alternatively, noise within the decrypted audio transmission can be removed by a denoiser service 514. The denoiser service 514 can analyze the audio transmission to classify audio portion(s) of the audio transmission as speech or noise, identified as noise based on a statistical analysis (e.g., a generalized mean) of the audio transmission. Any appropriate statistical analysis for noise detection, as in FIG. 2, may be used, such as statistical methods relating to error deviation and/or a generalized mean, such as the root mean square (RMS). The denoiser service 514 can, after identifying what components within the audio transmission is noise or speech, segregate the audio transmission into noise components (e.g., audio signatures) and speech components (e.g., audio signatures). The noise components can then be dynamically and/or automatically removed from the audio transmission in real- or near real-time. The denoiser service 514 can determine an active speech level based on the audio transmission segregation, once the noise has been removed.

In some embodiments, multiple speakers (e.g., actively speaking participants) corresponding to a single send side endpoint may be present, and the denoiser service 514 can identify each speaker. For example, the denoiser service 514 can determine the presence of a speaker and a separate, different speaker within an audio transmission. In some embodiments, separate speakers may be identified by an analysis that identifies two or more speaker characteristics within the audio transmission that identifies more than one speaker is present. The denoiser service 514 may even identify that one of the speakers has a speech level that is different from the second speaker. For example, one speaker may be seated further away than another speaker, and therefore one speaker may be picked up by the microphone 504a at a lower volume than the other speaker.

The audio transmission can then be processed by the normalizer service 516, which can normalize the audio transmission with other audio transmissions within the teleconference. The normalizer service 234 can adjust a gain of the audio transmission relative to the other audio transmissions such that the difference between the audio levels of the send side endpoints are reduced to be within a predefined range of amplitude levels. For example, a gain can be applied to adjust the audio transmission from send side endpoint 502a to reduce the difference between the audio levels of the transmissions from send side endpoint 502b, send side endpoint 502c, and send side endpoint 502d. Likewise, a gain can be applied to adjust the audio transmission from send side endpoint 502b to reduce the difference between the audio levels of the transmissions from send side endpoint 502a, send side endpoint 502c, and send side endpoint 502d; a gain can be applied to the adjust audio transmission from send side endpoint 502c to reduce the difference between the audio levels of the transmissions from send side endpoint 502a, send side endpoint 502b, and send side endpoint 502d; and a gain can be applied to adjust the audio transmission from send side endpoint 502d to reduce the differences between the audio levels of the transmissions from send side endpoint 502a, send side endpoint 502b, and send side endpoint 502c. Therefore, if the audio transmission is below the mean of the other audio transmissions, the gain can increase the loudness (e.g., increase the amplitude levels) of the audio transmission to match the other audio transmissions within the predefined range. If the audio transmission is below the mean of the other audio transmissions, however, the gain can then decrease the loudness (e.g., decrease the amplitude levels) of the audio transmission to match the other audio transmissions within the predefined range. The range of amplitude levels can be an accepted range, and each audio transmission can have an automatic gain control applied to each corresponding transmission to the teleconference.

Additionally, and/or alternatively, the normalizer service 516 can normalize the audio transmission based on the classification of audio signature(s) as speech. For example, the denoiser service 514 can analyze the audio transmission to identify if any portion of the audio transmission is speech (e.g., matches a speech signature). Any voice activity detection algorithm (VAD) used in speech processing can determine when there is speech present in the audio transmission. For those portions of the audio that are classified as speech, the normalizer service 516 can utilize those portions to determine the range within which all the audio transmissions are normalized. The other portions that are noise, silence, and/or otherwise not classified as speech, the normalizer service 516 can disregard, remove, and/or otherwise take out those portions when the range for normalization is determined. This can avoid unnecessary coding/transmission of silence packets in Voice over Internet Protocol (VoIP) applications, saving on computation and on network bandwidth.

Moreover, the normalizer service 516 can normalize multiple speakers within the same send side endpoint. For example, if one speaker is seated further away than another speaker, and therefore the speaker is picked up by the microphone 504a at a lower volume than the other speaker, then the normalizer service 516 can adjust the gain of the audio transmission based on which speaker is speaking. If the closer speaker is speaking, the normalizer service 516 can adjust the gain at a different value than the gain that would be applied to the further speaker (e.g., if both speakers need to be adjusted to a higher volume to match the other send side endpoint audio transmissions, then the further speaker would have a higher gain adjustment than the closer speaker).

In some embodiments, a selection service 532 may select the top audio transmissions for presentation at the teleconference. For example, in this embodiment, the top three speakers (and their corresponding audio transmissions are selected, although any number of top speakers may be selected). The top speakers may be selected based on a threshold ranking. Compute resources and network/bandwidth resources can be saved by only sending the audio transmissions of the top three speakers for output to the presentation within the teleconference. For example, cloud 510 can encrypt the outgoing top three audio transmissions through the encode service 520, which are then received by receive side endpoint 524. The receive side endpoint 524 can unencrypt the audio transmission through decode service 526, and then playback processing service 528 can output the audio transmission with loudspeaker 530. In the example shown, the speakers corresponding to send side endpoint 502a, send side endpoint 502b, and send side endpoint 502d have been selected to be decoded at decode service 526 and then for playback processing 528, while the audio for send side endpoint 502c has not been selected or sent to receive side endpoint 524. Therefore, the audio transmissions that reach a threshold ranking are output to the teleconference while output of the other audio transmissions that do not meet the threshold ranking are withheld.

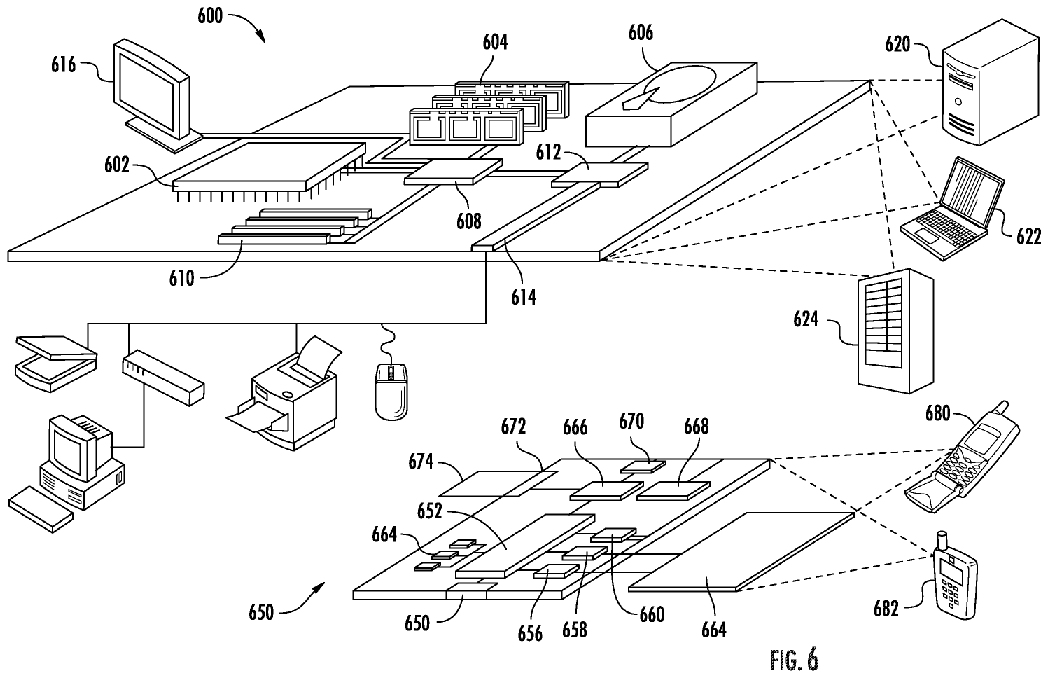

FIG. 6 illustrates a block diagram of computing devices 600, 650 that may be used to implement the systems and methods described in this document, as either a client or as a server or multiple servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Computing device 600 includes a processor 602, memory 604, a storage device 606, a high-speed interface 608 connecting to memory 604 and high-speed expansion ports 610, and a low-speed interface 612 connecting to low-speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high-speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. The computer-readable medium is not a propagating signal. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform method(s), such as those described above. The information carrier is a computer- or machine-readable medium, such as the memory 604, the storage device 606, or memory on processor 602.

The high-speed controller 608 manages bandwidth intensive operations for the computing device 600, while the low-speed controller 612 manages lower bandwidth-intensive operations. Such allocation of duties is illustrative only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth®, Ethernet, wireless Ethernet) may be coupled to input/output device(s), such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain computing device 600, 650, and/or an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above and may include secure information also. Thus, for example, expansion memory 674 may be provided as a security module for device 650 and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform method(s), such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, Wi-Fi, or other such transceiver (not shown). In addition, GPS receiver module 670 may provide additional wireless data to device 650, which may be used as appropriate by applications running on device 650.

Device 650 may also communicate audibly using audio codec 660, which may receive spoken information from a user and convert it to usable digital information. Audio codex 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in computer program(s) that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interactions with a user as well; for example, feedback provided to the user can be any form of sensory feedback (e.g., visual feedback, auditory feedback, or tactile feedback); and input from the user can be received in any form, including acoustic, speech, or tactile input.

It should be noted that, although normalization of audio transmissions is mentioned throughout the subject specification, implementations of the present disclosure are not limited to normalization. Rather, equalization can also be applied to audio transmissions in the same manner as described for normalization. For example, in some implementations, equalization may refer to the process of normalization (e.g., adjusting a gain for an audio transmission, modifying some other characteristic of an audio transmission, etc.). Alternatively, in some implementations, equalization may refer to modification of certain characteristics of an audio transmission other than gain (e.g., bass, treble, etc.). For example, a first audio transmission may be equalized based on a determined difference. The equalization may adjust certain characteristics of the first audio transmission (e.g., treble, bass, playbacks speed, etc.) relative to one or more second audio transmissions. As such, it should be broadly understood that normalization, equalization, or a combination of both can be applied using the implementations discussed herein.

The systems and techniques described here can be implemented in a computing system that includes a back-end component (e.g., as a data server), or that includes a middleware component (e.g., an application server), or that include a front-end component (e.g., a client computer having a graphical user interface or a Web browser through which a user can interact with an implementation of the systems and techniques described here), or any combination of such backend, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

What is claimed is:

1. A computer-implemented method for normalizing audio transmissions from multiple endpoints within a teleconference, the method comprising:
receiving, from a first participant of a teleconference, a first audio transmission for presentation at the teleconference;
analyzing the first audio transmission to classify one or more audio signatures of the first audio transmission as speech;
determining a difference between an audio level of the one or more audio signatures and an audio level of one or more second audio transmissions from one or more second participants of the teleconference received prior to the first audio transmission;
normalizing the first audio transmission based on the difference, wherein the normalization adjusts a gain of the first audio transmission relative to the one or more second audio transmissions; and
outputting the first audio transmission to the teleconference.

2. The computer-implemented method of claim 1, the method further comprising:
analyzing the first audio transmission to identify one or more other audio signatures of the first audio transmission as noise based on a statistical analysis identifying a generalized mean applied to the first audio transmission;
segregating the first audio transmission into noise components and speech components;
dynamically removing the noise components from the first audio transmission; and
determining an active speech level based on the first audio transmission segregation.

3. The computer-implemented method of claim 1, the method further comprising:
monitoring the first audio transmission to the teleconference, wherein a gain has been applied to the first audio transmission after normalization; and
based on a detection of the audio level of the first audio transmission being above a threshold value, applying a limiter service to attenuate the first audio transmission to dynamically bring the audio level below the threshold value.

4. The computer-implemented method of claim 1, the method further comprising:
applying a voice activity detection (VAD) analysis to the first audio transmission;
based on the VAD analysis, determining that the one or more audio signatures of the first audio transmission from the first participant corresponds to an active speaker;
selecting the first audio transmission for presentation at the teleconference based on a comparison between the first audio transmission and audio transmissions from other participants of the teleconference after normalizing, wherein the active speaker within the first audio transmission is determined to meet a threshold ranking; and
outputting the first audio transmission to the teleconference while withholding output of the other audio transmissions that do not meet the threshold ranking.

5. The computer-implemented method of claim 1, wherein the normalization adjusts the audio level of the first audio transmission to match a target output level, and wherein the gain applied to the first audio transmission adjusts the audio level of the first audio transmission to within a predefined range of amplitude levels.

6. The computer-implemented method of claim 5, wherein the target output level is based at least in part on the one or more second audio transmissions from the one or more second participants, and wherein first audio transmission and the one or more second audio transmissions are received within a same session of the teleconference.

7. The computer-implemented method of claim 5, wherein the first audio transmission and the one or more second audio transmissions are received within a first session of the teleconference, and wherein the target output level is based at least in part on other audio transmissions received within one or more second sessions of the teleconference occurring prior to the first session of the teleconference.

8. The computer-implemented method of claim 1, wherein each audio transmission has an automatic gain control applied to each corresponding transmission to the teleconference.

9. The computer-implemented method of claim 1, the method further comprising:
determining a first speaker and a second speaker is present within the first audio transmission, wherein the first speaker has a speech level different from the second speaker; and
normalizing the first speaker and the second speaker within the first audio transmission.

10. A computing system for normalizing audio streams from multiple endpoints within a teleconference comprising:
one or more processors; and
one or more memory elements including instructions that when executed cause the one or more processors to:
receive, from a participant of a teleconference, a first audio transmission for presentation at the teleconference;
process the first audio transmission with a denoiser module to remove audio signatures corresponding to noise from the first audio transmission;
process the first audio transmission with a voice activity detection (VAD) module to classify one or more audio signatures of the first audio transmission as speech;
determine a difference between an audio level of the one or more audio signatures and an audio level of one or more second audio transmissions from one or more second participants received prior to the first audio transmission;
normalize the first audio transmission based on the difference, wherein the normalization adjusts a gain of the first audio transmission relative to the one or more second audio transmissions; and
output the first audio transmission to the teleconference.

11. The computing system of claim 10, the instructions further causing the one or more processors to:
monitor the first audio transmission to the teleconference, wherein a gain has been applied to the first audio transmission after normalization; and
based on a detection of the audio level of the first audio transmission being above a threshold value, apply a limiter service to attenuate the first audio transmission to dynamically bring the audio level below the threshold value.

12. The computing system of claim 10, the instructions further causing the one or more processors to:
process the first audio transmission with the VAD module to determine that the one or more audio signatures of the first audio transmission corresponds to an active speaker;
select the first audio transmission for presentation at the teleconference based on a comparison between the first audio transmission and audio transmissions from other participants in the teleconference after normalizing, wherein the active speaker within the first audio transmission is determined to meet a threshold ranking; and
output the first audio transmission to the teleconference while withholding output of the other audio transmissions that do not meet the threshold ranking.

13. The computing system of claim 10, wherein the normalization adjusts the audio level of the first audio transmission to match a target output level, and wherein the gain applied to the first audio transmission adjusts the audio level of the first audio transmission to within a predefined range of amplitude levels.

14. The computing system of claim 10, wherein each audio transmission has an automatic gain control applied to each corresponding transmission to the teleconference.

15. The computing system of claim 10, the instructions further causing the one or more processors to:
determine a first speaker and a second speaker is present within the first audio transmission, wherein the first speaker has a speech level different from the second speaker; and
normalize the first speaker and the second speaker within the first audio transmission.

16. A non-transitory computer readable medium embodied in a computer-readable storage device and comprising instructions for normalizing audio transmissions from multiple endpoints within a teleconference that, when executed by a processor, cause the processor to:
receive, from a first participant of a teleconference, a first audio transmission for presentation at the teleconference;
analyze the first audio transmission to classify one or more audio signatures of the first audio transmission as speech;
determine a difference between an audio level of the one or more audio signatures and an audio level of one or more second audio transmissions from one or more second participants in the teleconference received prior to the first audio transmission;
normalize the first audio transmission based on the difference, wherein the normalization adjusts a gain of the first audio transmission relative to the one or more second audio transmission; and
output the first audio transmission to the teleconference.

17. The non-transitory computer readable medium of claim 16, the instructions further causing the processor to:
analyze the first audio transmission to identify one or more other audio signatures of the first audio transmission as noise based on a statistical analysis identifying a generalized mean unique to the first audio transmission;
segregate the first audio transmission into noise components and speech components;
dynamically remove the noise components from the first audio transmission; and
determine an active speech level based on the first audio transmission segregation.

18. The non-transitory computer readable medium of claim 16, the instructions further causing the processor to:
monitor the first audio transmission to the teleconference, wherein a gain has been applied to the first audio transmission after normalization; and
based on a detection of the audio level of the first audio transmission being above a threshold value, apply a limiter service to attenuate the first audio transmission to dynamically bring the audio level below the threshold value.

19. The non-transitory computer readable medium of claim 15, the instructions further causing the processor to:
apply a voice activity detection (VAD) analysis to the first audio transmission; based on the VAD analysis, determining that the one or more audio signatures of the first audio transmission from the first participant corresponds to an active speaker;
select the first audio transmission for presentation at the teleconference based on a comparison between the first audio transmission and audio transmissions from other participants of the teleconference after normalizing, wherein the active speaker within the first audio transmission is determined to meet a threshold ranking; and
output the first audio transmission to the teleconference while withholding output of the other audio transmissions that do not meet the threshold ranking.

20. The non-transitory computer readable medium of claim 15, wherein the normalization adjusts the audio level of the first audio transmission to match a target output level, and wherein the gain applied to the first audio transmission adjusts the audio level of the first audio transmission to within a predefined range of amplitude levels.
